(19) United States
(12) Patent Application Publication
(10) Pub. No.: US 2025/0198443 A1
(43) Pub. Date: Jun. 19, 2025

(54) Reusable Hanging Fastener with Sleeve

(71) Applicant: Ivan Boggs, Weirton, WV (US)

(72) Inventor: Ivan Boggs, Weirton, WV (US)

(21) Appl. No.: 18/980,727

(22) Filed: Dec. 13, 2024

Related U.S. Application Data
(60) Provisional application No. 63/610,452, filed on Dec. 15, 2023.

(51) Int. Cl. F16B 13/12

(52) U.S. Cl. CPC F16B 13/124

(57) ABSTRACT

A reusable hanging fastener with a sleeve for fixing or hanging objects on a wall includes a body having a threaded post and a head, and a sleeve comprised of a resilient polymer. The sleeve further includes a hollow core, a first end having internal threading, and a second end comprising a washer. The threaded post is engaged with the internal threading of the first end of the sleeve. The head of the body further includes a gripping feature configured to receive a tool and the body further includes a spacer between the threaded post and the head. The washer of the sleeve includes protrusions extending from a surface of the washer toward the first end of the sleeve.

### CROSS REFERENCE TO RELATED APPLICATION

This application claims the benefit of U.S. Provisional Patent Application No. 63/610,452, which was filed Dec. 15, 2023, the disclosure of which is hereby incorporated by reference in its entirety.

### BACKGROUND

### Field of the Disclosure

The present disclosure relates to a fastener and, more specifically, to a reusable hanging fastener with a sleeve for fixing or hanging objects on a vertical surface such as a wall, which may be used in different wall materials, and which allows for easier, faster, and more reliable installation, removal, and reuse.

### Description of Related Art

Fasteners such as nails, screws, bolts, hooks, and eye bolts are well known for their use in vertical surfaces such as walls, panels, and partitions for affixing or hanging objects such as pictures, shelves, decorations, and things of the like. Fasteners are typically chosen based on the material of the wall or partition to which they are being mounted.

For example, a drywall anchor, also known as a wall anchor, is an insert, typically made of plastic, which is combined with an appropriate screw to allow mounting anywhere on a drywall panel or similar hollow wall such as those including gypsum board, sheetrock, and plaster, where a stud is unavailable. A hole is predrilled in the wall material and the anchor is inserted. Often, insertion of the anchor is accomplished by tapping, pounding, or screwing. The screw or bolt is then inserted into the anchor, and as the screw is tightened into the anchor, the anchor expands to grip the drywall or other wall material.

Similarly, toggle bolts are bolts threaded with arms known as toggles or toggle arms. The toggle bolt is inserted into a predrilled hole, the arms open behind the wall or expand within the predrilled hole as the bolt is tightened by threading further into the toggle arms, and a holding force is produced on the sheet of drywall between the toggle arms and the bolt.

Another similar fastener is known as a molly bolt. Molly bolts include a metal anchor insert which expands similarly to other anchors as the bolt is threaded into the anchor such that the molly expands or metal wings are deployed from the molly and expand in the predrilled hole.

In masonry applications such as brick, cement, and cinder block, similar anchors are used. Typically, masonry anchors are more rigid so they can be pounded into a predrilled hole in the hard brick or cement material. Masonry or cement anchors are more robust than drywall anchors and thus typically require more applied force to expand and properly grip the cement, brick, or stone. Such fasteners all create a mount point by distribution of an applied load over an increased surface area as compared to a standard nail or screw.

However, these known fasteners have several drawbacks, including complicated installation and the inability to be used more than once. Such fasteners may include multiple pieces and require that a hole be precisely predrilled in the drywall, wood panel, or masonry to accommodate the toggle, drywall anchor, or masonry anchor. If the hole is drilled too small, the insert will not fit in the material, and if the hole is drilled too large, the fastener will not be able to expand enough in the hole or behind the hole to properly secure the fastener to the wall.

Additionally, these fasteners may only be used once, as their installation and/or removal often damages the fastener such that the fastener will not function as intended if an attempt is made to use the fastener again. For example, once the plastic or metal insert is expanded, it may break or may be deformed such that it cannot be removed from its first installation. In certain instances, when the bolt or screw is removed, the anchor, molly, or toggle may remain stuck in the wall, or fall behind the wall such that there is no way to retrieve it for a second use. Even if the anchor is able to be removed from the wall, it is rarely suitable for a second use as the deformation prohibits the fastener from being inserted into a hole sized for the intended use or prohibits the fastener from applying the necessary holding force.

In view of the foregoing, there exists a need for a reusable hanging fastener with a sleeve for fixing or hanging objects on a vertical surface such as a wall, which may be used in different wall materials, and which allows for easier, faster, and more reliable installation, removal, and reuse.

### SUMMARY

Accordingly, aspects of the present disclosure are directed to non-limiting embodiments of a reusable hanging fastener with a sleeve for fixing or hanging objects on a vertical surface such as a wall, which may be used in different wall materials such as drywall sheets, gypsum board, sheetrock, plaster, wood panels, brick, cement, stone, and things of the like. Further, aspects of the present disclosure allow for easier, faster, and more reliable installation, removal, and reuse.

According to an aspect of the disclosure, a reusable hanging fastener with a sleeve for fixing or hanging objects on a wall includes a body having a threaded post and a head and a sleeve comprised of a resilient polymer. The sleeve further includes a hollow core, a first end having internal threading, and a second end having a washer. The threaded post is engaged with the internal threading of the first end of the sleeve.

In some non-limiting embodiments, the head further comprises a gripping feature configured to receive a tool. In some non-limiting embodiments, the gripping feature comprises a screw drive such as Phillips, flat, Allen, hex, or the like.

In some non-limiting embodiments, the body further comprises a spacer between the threaded post and the head. In some non-limiting embodiments, the spacer comprises a rim protruding from the body and an unthreaded portion between the rim and the head.

In some non-limiting embodiments, the head comprises a hook. In some non-limiting embodiments, the head comprises a loop.

In some non-limiting embodiments, the threaded post comprises a tapered end having a point.

In some non-limiting embodiments, the body is comprised of aluminum, stainless steel, or a metal alloy.

In some non-limiting embodiments, the washer extends radially from the second end of the sleeve. In some non-limiting embodiments, the washer comprises protrusions extending from a surface of the washer toward the first end of the sleeve. In some non-limiting embodiments, the protrusions are pointed teeth.

In some non-limiting embodiments, the resilient polymer is an elastomer comprised of natural rubber, synthetic rubber, silicone, ethylene propylene diene terpolymer (EPDM), a thermoplastic elastomer (TPE), or the like.

According to another aspect of the disclosure, a reusable hanging fastener with a sleeve for fixing or hanging objects on a wall includes a body having a threaded post, a head having a gripping feature configured to receive a tool, and a spacer between the threaded post and the head. The spacer has a rim protruding from the body and an unthreaded portion between the rim and the head. The fastener further includes a sleeve made of a resilient polymer, and the sleeve further includes a hollow core, a first end having internal threading, and a second end comprising a washer having protrusions extending from a surface of the washer toward the first end of the sleeve. The threaded post is engaged with the internal threading of the first end of the sleeve. The fastener is configured such that as the threaded post is threaded further into the internal threading of the sleeve while the sleeve is engaged with a wall, the first end of the threaded post extends from the first end of the sleeve, the first end of the sleeve is drawn toward the second end of the sleeve, and the sleeve expands radially and deforms helically.

In some non-limiting embodiments, the gripping feature comprises a screw drive such as Phillips, flat, Allen, hex, or the like.

In some non-limiting embodiments, the head comprises a hook or a loop.

In some non-limiting embodiments, the body is comprised of aluminum, stainless steel, or a metal alloy and the resilient polymer is an elastomer comprised of natural rubber, synthetic rubber, silicone, ethylene propylene diene terpolymer (EPDM), a thermoplastic elastomer (TPE), or the like.

According to another aspect of the disclosure, a method of mounting a fastener to a wall surface includes providing a fastener. The fastener includes a body having a threaded post, a head having a gripping feature configured to receive a tool, and a spacer between the threaded post and the head. The spacer has a rim protruding from the body and an unthreaded portion between the rim and the head. The fastener further includes a sleeve made of a resilient polymer, and the sleeve further includes a hollow core, a first end having internal threading, a second end having a washer, and the washer having protrusions extending from a surface of the washer toward the first end of the sleeve. The threaded post is engaged with the internal threading of the first end of the sleeve. The fastener is configured such that as the threaded post is threaded further into the internal threading of the sleeve while the sleeve is engaged with a wall, the first end of the threaded post extends from the first end of the sleeve, the first end of the sleeve is drawn toward the second end of the sleeve, and the sleeve expands radially and deforms helically. The method further includes predrilling a hole in the wall, the diameter of the hole being approximately the same or larger than an outer diameter of the sleeve. Further, the method includes inserting the fastener into the hole such that the protrusions engage with a surface of the wall. The method further includes threading the threaded post further into the internal threading of the sleeve such that the first end of the threaded post extends from the first end of the sleeve, the first end of the sleeve is drawn toward the second end of the sleeve, and the sleeve expands radially and deforms helically such that the sleeve imparts a radial holding force on the hole, a clamping force on the wall, or a combination thereof.

In some non-limiting embodiments, the head comprises a hook or a loop.

In some non-limiting embodiments, the body is comprised of aluminum, stainless steel, or a metal alloy and the resilient polymer is an elastomer comprised of natural rubber, synthetic rubber, silicone, ethylene propylene diene terpolymer (EPDM), a thermoplastic elastomer (TPE), or the like.

Further details and advantages of the various examples described in detail herein will become clear upon reviewing the following detailed description of the various examples in conjunction with the accompanying drawing figures.

### BRIEF DESCRIPTION OF THE DRAWINGS

Additional advantages and details are explained in greater detail below with reference to the exemplary embodiments that are illustrated in the accompanying schematic figures, in which:

FIG. 1 is a perspective view of a non-limiting embodiment of a fastener in accordance with the present disclosure;

FIG. 2 is a perspective view of a non-limiting embodiment of a fastener in accordance with the present disclosure;

FIGS. 3A and 3B are a side view and a perspective view of a non-limiting embodiment of a body of a fastener in accordance with the present disclosure;

FIGS. 4A and 4B are a side view and a perspective view of a non-limiting embodiment of a body of a fastener in accordance with the present disclosure;

FIGS. 5A-5D are various views of a non-limiting embodiment of a sleeve of a fastener in accordance with the present disclosure;

FIGS. 6A and 6B are perspective views of a non-limiting embodiment of a fastener in accordance with the present disclosure;

FIGS. 7A and 7B are perspective views of a non-limiting embodiment of a fastener in accordance with the present disclosure;

FIGS. 8A-8D are various views of an implementation of a non-limiting embodiment of a fastener in accordance with the present disclosure; and

FIGS. 9A-9C are various views of an implementation of a non-limiting embodiment of a fastener in accordance with the present disclosure.

Corresponding reference characters indicate corresponding parts throughout the several views. The exemplifications set out herein illustrate exemplary embodiments of the disclosure, and such embodiment are not to be construed as limiting the scope of the disclosure in any manner.

### DETAILED DESCRIPTION

For purposes of the description hereinafter, the terms “end”, “upper”, “lower”, “right”, “left”, “vertical”, “horizontal”, “top”, “bottom”, “lateral”, “longitudinal”, and derivatives thereof shall relate to embodiments or aspects as they are oriented in the drawing figures. However, it is to be understood that embodiments or aspects may assume various alternative variations and step sequences, except where expressly specified to the contrary. It is also to be understood that the specific devices and processes illustrated in the attached drawings, and described in the following specification, are simply non limiting Exemplary embodiments or aspects. Hence, specific dimensions and other physical characteristics related to the embodiments or aspects of the embodiments or aspects disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one”. As used in the specification and the claims, the singular form of “a”, “an”, and “the” include plural referents, such as unless the context clearly dictates otherwise. Where only one item is intended, the term “one” or similar language is used. Also, as used herein, the terms “has”, “have”, “having”, or the like are intended to be open-ended terms. Further, the phrase “based on” is intended to mean “based at least partially on” unless explicitly stated otherwise. Further, the phrase “based on” is intended to mean “based at least partially on” unless explicitly stated otherwise.

Embodiments of the present disclosure are directed to a reusable hanging fastener with a sleeve for fixing or hanging objects on a wall. According to the present disclosure, a fastener may include a body having a threaded post and a head, and a sleeve comprised of a resilient polymer. The sleeve may further include a hollow core, a first end having internal threading, and a second end having a washer. The threaded post may be engaged with the internal threading of the first end of the sleeve. In some non-limiting embodiments, the head may further include a gripping feature configured to receive a tool. In some non-limiting embodiments, the gripping feature may be a screw drive such as Phillips, flat, Allen, hex, or the like. In some non-limiting embodiments, the body may further include a spacer between the threaded post and the head. In some non-limiting embodiments, the spacer may have a rim protruding from the body and an unthreaded portion between the rim and the head. In some non-limiting embodiments, the head may be a hook. In some non-limiting embodiments, the head may be a loop. In some non-limiting embodiments, the threaded post may have a tapered end having a point. In some non-limiting embodiments, the body may be made of aluminum, stainless steel, or a metal alloy. In some non-limiting embodiments, the washer may extend radially from the second end of the sleeve. In some non-limiting embodiments, the washer may have protrusions extending from a surface of the washer toward the first end of the sleeve. In some non-limiting embodiments, the protrusions may be pointed teeth. In some non-limiting embodiments, the resilient polymer may be an elastomer comprised of natural rubber, synthetic rubber, silicone, ethylene propylene diene terpolymer (EPDM), a thermoplastic elastomer (TPE), or the like.

In this way, embodiments of the present disclosure allow for a reusable hanging fastener with a sleeve for fixing or hanging objects on a vertical surface such as a wall, which may be used in different wall materials, and which allows for easier, faster, and more reliable installation, removal, and reuse.

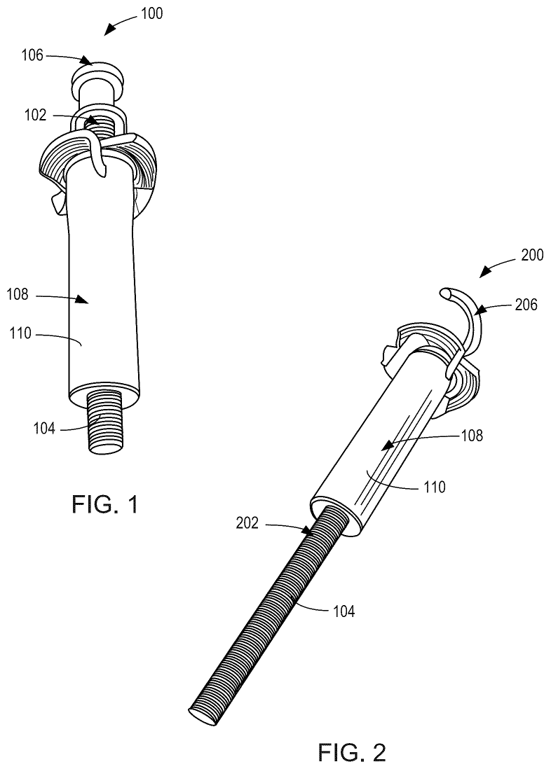

Referring now to FIG. 1, FIG. 1 is a perspective view of a non-limiting embodiment of fastener 100 in accordance with the present disclosure. As shown in FIG. 1, fastener 100 may include a body 102 having a threaded post 104 and a head 106. As further shown in FIG. 1, fastener 100 may include sleeve 108 comprised of resilient polymer 110.

Referring now to FIG. 2, FIG. 2 is a perspective view of a non-limiting embodiment of fastener 200 in accordance with the present disclosure. Fastener 200 may be the same as or similar to fastener 100 as shown in FIG. 1. As shown in FIG. 2, fastener 200 may include a body 202 having a threaded post 104 and a head 206, and sleeve 108 comprised of resilient polymer 110.

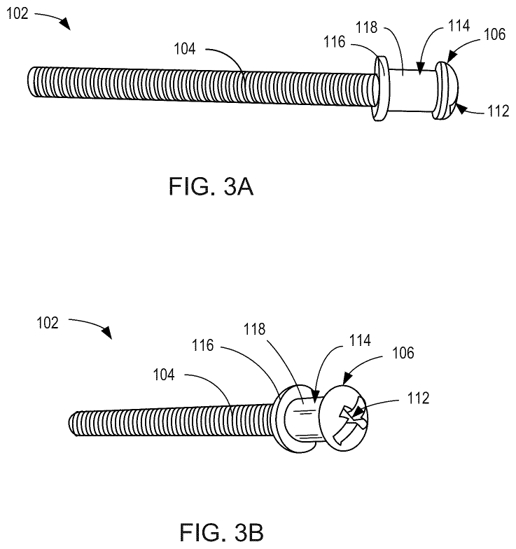

Referring now to FIGS. 3A and 3B, FIGS. 3A and 3B are a side view and a perspective view of a non-limiting embodiment of body 102 of fastener 100 in accordance with the present disclosure. As shown in FIGS. 3A and 3B, body 102 of fastener 100 may include threaded post 104 and head 106. In some non-limiting embodiments, as shown in FIG. 3B, head 106 may include gripping feature 112, and gripping feature 112 may be a screw drive such as a Phillips drive, a flat drive, an Allen drive, a hex drive, or the like. Gripping feature 112 may allow a user to engage body 102 of fastener 100 with a tool as a screwdriver or wrench to aid with installation and removal of fastener 100. When engaged with a tool, gripping feature 112 may allow a user to apply rotational force or torsion to thread threaded post 104 further into or out of sleeve 108.

In some non-limiting embodiments, as shown in FIGS. 3A and 3B, body 102 of fastener 100 may further include spacer 114 between threaded post 104 and head 106. Spacer 114 may further include rim 116 and unthreaded portion 118 between rim 116 and head 106. Spacer 114 may allow fastener 100 to extend from a wall surface when fully installed and may provide a user with a projection from which to hang objects such as pictures, shelves, decorations, and things of the like. Rim 116 may also prevent over insertion of threaded post 104 into sleeve 108.

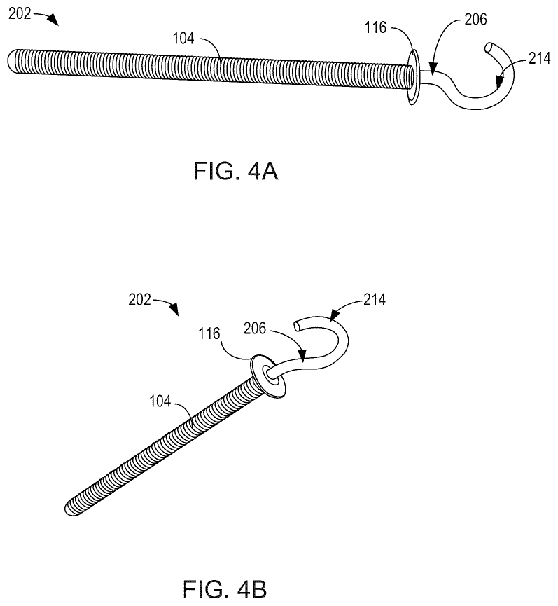

Referring now to FIGS. 4A and 4B, FIGS. 4A and 4B are a side view and a perspective view of a non-limiting embodiment of body 202 of fastener 200 in accordance with the present disclosure. Body 202 of fastener 200 may be the same as or similar to body 102 as shown in FIGS. 3A and 3B. Body 202 may include threaded post 104. In some non-limiting embodiments, as shown in FIGS. 4A and 4B, head 206 of body 202 may be a hook 214. In some non-limiting embodiments, head 206 of body 202 may be a loop. Hook 214 or the loop may allow fastener 200 to extend from a wall surface when fully installed and may provide a user with a projection or attachment point from which to hang objects such as pictures, shelves, decorations, and things of the like. Hook 214 or the loop of head 206 may also allow a user to apply rotational force or torsion to thread threaded post 104 further into or out of sleeve 108. A user may apply force to head 206 by hand, or a tool such as plyers or a wrench may be used to grip hook 214 or the loop to apply rotational force to threaded post 104.

In some non-limiting embodiments, threaded post 104 of fastener 100, 200 may include a tapered end having a point. The tapered end and point may allow for easier installation of fastener 100, 200, should body 102, 202 need to penetrate a wall or material behind a wall surface during installation.

In some non-limiting embodiments, as may be appreciated from FIGS. 3A-4B, threaded post 104 and thus body 102, 202 may be different lengths and/or diameters to accommodate different wall thicknesses or installation needs such as pull-out, shear, or other force related requirements.

In some non-limiting embodiments, body 102, 202 may be made from aluminum, stainless steel, or another metal which allows fastener 100, 200 to meet installation requirements such as strength, weight, corrosion resistance, or the like. Similarly, body 102, 202 may be galvanized or coated with another material such as zinc, iron, or steel, or coated with an anti-slip or anti-corrosion material, to further meet installation needs.

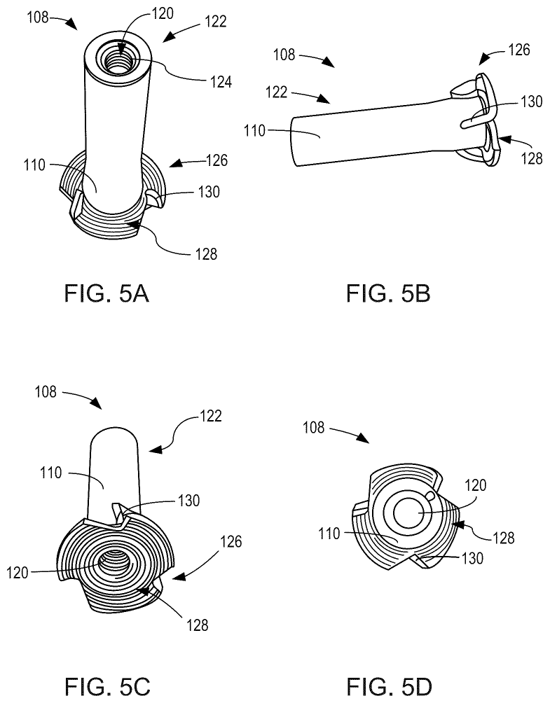

Referring now to FIGS. 5A-5D, FIGS. 5A-5D are various views of a non-limiting embodiment of sleeve 108 of fastener 100, 200 in accordance with the present disclosure. As shown in FIGS. 5A-5D, sleeve 108 may be made of resilient polymer 110. As discussed herein, resilient polymer 110 may have properties that allow sleeve 108 to be used and then reused multiple times such that fastener 100, 200 may be used and then reused multiple times. In some non-limiting embodiments, resilient polymer 110 may be an elastomer comprised of natural rubber, synthetic rubber, silicone, ethylene propylene diene terpolymer (EPDM), a thermoplastic elastomer (TPE), or the like. Sleeve 108 may further comprise hollow core 120, first end 122 having internal threading 124, and second end 126 having washer 128. Internal threading 124 of first end 122 of sleeve 108 may be sized and configured such that threaded post 104 may engage with the internal threading 124. In some non-limiting embodiments, for example, internal threading 124 may be provided by tapping hollow core 120 at first end 122 of sleeve 108, such as by directly tapping resilient polymer 110 of sleeve 108. In some non-limiting embodiments, internal threading 124 may be accomplished by providing a fastener such as a nut in hollow core 120 at first end 122 of sleeve 108. In such exemplary embodiments, the fastener or nut may be mechanically, chemically, or otherwise fastened in hollow core 120 at first end 122 of sleeve 108.

In some non-limiting embodiments, sleeve 108 may be different lengths and/or diameters to accommodate different wall thicknesses or installation needs such as pull-out, shear, or other force related requirements. In some non-limiting embodiments, an exterior diameter of sleeve 108 may be chosen to correspond to a diameter of an existing or intended hole in a wall, which may be chosen based on the intended use of fastener 100, 200. In some non-limiting embodiments, an exterior diameter of sleeve 108 may be a standard imperial or metric unit so as to correspond to existing drill bit sizes, and thus, the hole that is drilled in the wall for application of fastener 100, 200. In some exemplary embodiments, an exterior diameter of sleeve 108 may range from 1/16 inch (0.0625 inch) to 1 inch. For example, the exterior diameter of sleeve 108 may be ⅛ inch (0.125 inch), 3/16 inch (0.1875 inch), ¼ inch (0.25 inch), 5/16 inch (0.3125 inch), or ½ inch (0.5 inch). Threaded post 104 may be proportionally sized and configured to correspond to sleeve 108. For example, in some non-limiting embodiments, threaded post 104 may have a length, and the length may be longer to correspond to sleeve 108 having a larger diameter, or the length of threaded post 104 may be shorter to correspond to sleeve 108 having a smaller diameter. Similarly, threaded post 104 may have an exterior diameter that corresponds proportionally to the exterior diameter of sleeve 108.

In some non-limiting embodiments, washer 128 may extend radially from second end 126 of the sleeve 108. Further, as shown in FIGS. 5A-5D, washer 128 may include one or more protrusions 130 extending from a surface of the washer toward the first end of the sleeve. In some non-limiting embodiments, protrusions 130 may be pointed teeth. Protrusions 130 of washer 128 may be configured to engage a wall surface when fastener 100, 200 is inserted in a hole in a wall surface for mounting.

In some non-limiting embodiments, protrusions 130 may penetrate the wall surface such that a gripping of the wall surface occurs, which provides an anti-rotational effect. This engagement or gripping may allow body 102, 202 to rotate relative to sleeve 108, but stop sleeve 108 from rotating relative to a wall surface or a hole in a wall surface. This may allow threaded post 104 to be threaded further into or out of internal threading 124.

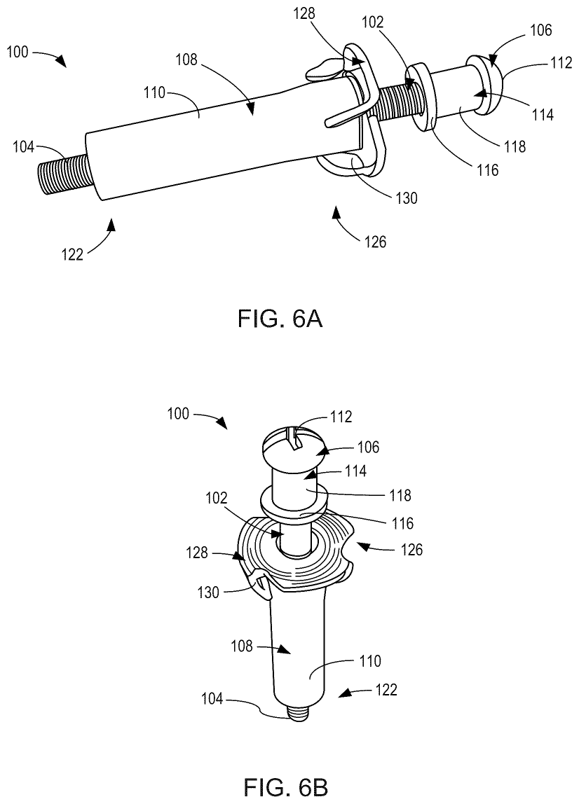

Referring now to FIGS. 6A and 6B, FIGS. 6A and 6B are additional perspective views of a non-limiting embodiment of fastener 100 in accordance with the present disclosure. As described hereinabove, fastener 100 may include body 102 having threaded post 104, and head 106. Head 106 may have gripping feature 112 which may be configured to receive a tool. Body 102 may further include spacer 114 between threaded post 104 and head 106, and spacer 114 may have rim 116 and unthreaded portion 118 between rim 116 and head 106. Fastener 100 may further include sleeve 108 made of resilient polymer 110 and may include hollow core 120 (as shown in FIG. 5A), first end 122 having internal threading 124 (as shown in FIG. 5A), and second end 126 having washer 128. Washer 128 may include protrusions 130 extending from a surface of the washer toward first end 122 of sleeve 108, and protrusions 130 may be pointed teeth. Threaded post 104 may be engaged with internal threading 124 of first end 122 of sleeve 108. In some non-limiting embodiments, the configuration whereby threaded post 104 is engaged with internal threading 124 of first end 122 of sleeve 108, first end 122 of sleeve 108 is not drawn toward second end 126 of the sleeve 108, and sleeve 108 is not expanded radially or deformed helically, may define a first state.

Fastener 100 may be configured such that as the threaded post 104 is threaded further into internal threading 124 of sleeve 108 while sleeve 108 is engaged with a wall, first end 122 of threaded post 104 extends from first end 122 of sleeve 108, first end 122 of sleeve 108 may be drawn toward second end 126 of the sleeve 108, and sleeve 108 may expand radially and deform helically. As sleeve 108 expands radially and deforms helically behind a wall or in a hole in a wall, sleeve 108 imparts a radial holding force on the hole, a clamping force on the wall, or a combination thereof. The clamping or radial force allows an object to be fixed or hung from fastener 100 without fastener 100 being pulled out from the wall. In some non-limiting embodiments, this configuration whereby first end 122 of sleeve 108 is drawn toward second end 126 of the sleeve 108, and sleeve 108 has expanded radially and deformed helically may define a second state.

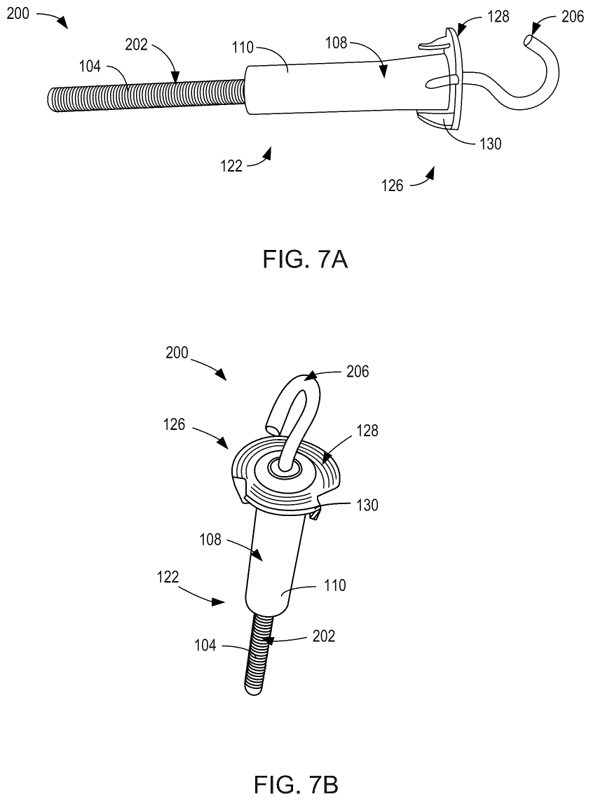

Referring now to FIGS. 7A and 7B, FIGS. 7A and 7B are additional perspective views of a non-limiting embodiment of fastener 200 in accordance with the present disclosure. As described hereinabove, fastener 200 may be the same as or similar to fastener 100 and may include body 202 having threaded post 104, and head 206. Head 206 may be hook 214 (as shown in FIGS. 4A and 4B) or a loop. Fastener 200 may further include sleeve 108 made of resilient polymer 110 and may include hollow core 120 (as shown in FIG. 5A), first end 122 having internal threading 124 (as shown in FIG. 5A), and second end 126 having washer 128. Washer 128 may include protrusions 130 extending from a surface of the washer toward first end 122 of sleeve 108, and protrusions 130 may be pointed teeth. Threaded post 104 may be engaged with internal threading 124 of first end 122 of sleeve 108. In some non-limiting embodiments, the configuration whereby threaded post 104 is engaged with internal threading 124 of first end 122 of sleeve 108, first end 122 of sleeve 108 is not drawn toward second end 126 of the sleeve 108, and sleeve 108 is not expanded radially or deformed helically, may define a first state.

Fastener 200 may be configured such that as the threaded post 104 is threaded further into internal threading 124 of sleeve 108 while sleeve 108 is engaged with a wall, first end 122 of threaded post 104 extends from first end 124 of sleeve 108, first end 122 of sleeve 108 may be drawn toward second end 126 of the sleeve 108, and sleeve 108 may expand radially and deform helically. As sleeve 108 expands radially and deforms helically behind a wall or in a hole in a wall, sleeve 108 imparts a radial holding force on the hole, a clamping force on the wall, or a combination thereof. The clamping or radial force allows an object to be fixed or hung from fastener 200. In some non-limiting embodiments, this configuration whereby first end 122 of sleeve 108 is drawn toward second end 126 of the sleeve 108, and sleeve 108 has expanded radially and deformed helically may define a second state.

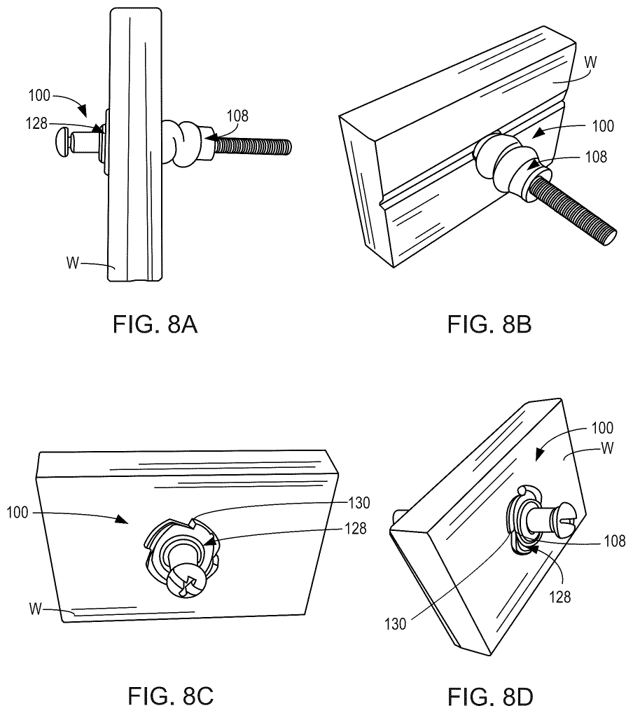

Referring now to FIGS. 8A-8D, FIGS. 8A-8D are various views of implementations of non-limiting embodiments of fastener 100 in accordance with the present disclosure. These views are exemplary of fastener 100 installed and ready for an object to be hung therefrom. FIGS. 8A and 8B show radial expansion and helical deformation of sleeve 108 as described above, which causes the clamping force on wall W. FIGS. 8C and 8D show the engagement between the protrusions 130 of washer 128 with the surface of wall W, as described above.

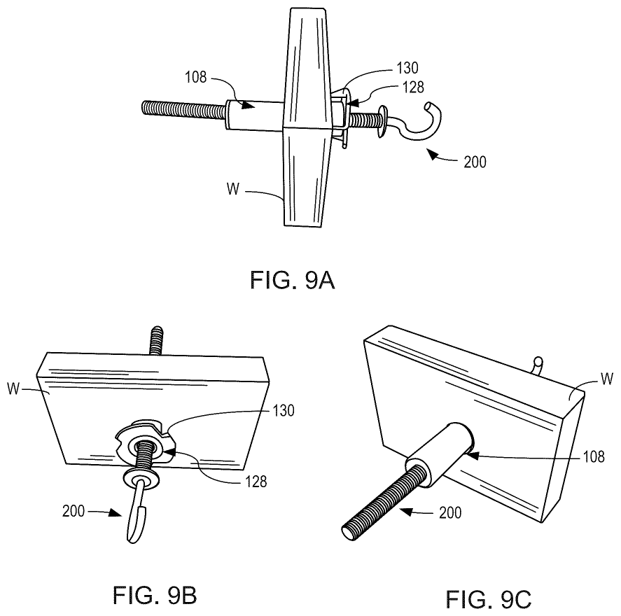

Referring now to FIGS. 9A-9C, FIGS. 9A-9C are various views of implementations of non-limiting embodiments of fastener 200 in accordance with the present disclosure. These views are exemplary of fastener 200 inserted into a hole in wall W. FIGS. 9A and 9B show that during removal sleeve 108 is no longer radial expanded or helically deformed. Thus, there is no clamping force on wall W. FIGS. 8A and 8B also show the protrusions 130 of washer 128 disengaged from wall W, and washer 128 pulled away from the surface of wall W. As shown, sleeve 108 has returned to its original uninstalled form as in the first state, for example, and fastener 200 is ready to be pulled out from the hole in wall W and used again.

Additionally, FIGS. 8A-9C show wall W as a generic wall. However, as described above, fastener 100, 200 may be implemented in any number of wall materials, including but not limited to drywall sheets, gypsum board, sheetrock, plaster, wood, brick, cement, stone, and materials of the like. For example, fastener 100, 200 may be particularly well suited for applications in wood panel or plywood walls.

Further, although fastener 100, 200 is generally discussed herein for use with uniform holes that are formed in a wall by drilling, such as by pre-drilling, it is considered that fastener 100, 200 is also applicable for use with existing holes in a wall, such as holes that do not have a uniform diameter or circumference. Such non-uniform holes may be a result of unintentional damage to a wall. For example, not only may removal of known fasteners damage the fasteners themselves, but removal of such fasteners may also damage the wall to which they were previously attached, by leaving a non-uniform whole in the wall. Fastener 100, 200 is configured for use with such non-uniform holes. Particularly, the radial expansion and helical deformation of sleeve 108 described herein allows fastener 100, 200 to still apply a clamping force on wall W regardless of whether the hole fastener 100, 200 is applied to is uniform or non-uniform. Similarly, because sleeve 108 is no longer radially expanded or helically deformed during removal, the damage caused to the wall or hole in the wall by known fasteners is avoided by fastener 100, 200 during removal.

Another aspect of the disclosure is a method of mounting fastener 100, 200 to a wall surface. The method may include providing a fastener, such as fastener 100, 200, or an equivalent thereof. Accordingly, the fastener may include a body (e.g., body 102, 202), having a threaded post (e.g., threaded post 104), a head (e.g., head 106, 206), and the head may have a gripping feature configured to receive a tool (e.g., gripping feature 112). In some non-limiting embodiments, the body may further include a spacer (e.g., spacer 114) between the threaded post and the head. In some non-limiting embodiments, the spacer may include a rim (e.g., rim 116) protruding from the body and an unthreaded portion (e.g., unthreaded portion 118) between the rim and the head. The fastener may further include a sleeve (e.g., sleeve 108), which may be made of a resilient polymer (e.g., resilient polymer 110). In some non-limiting embodiments, the sleeve may further include a hollow core (e.g., hollow core 120), a first end (e.g., first end 122) which may have internal threading (e.g., internal threading 124), and a second end (e.g., second end 126) which may have a washer (e.g., washer 12. In some non-limiting embodiments, the washer may have protrusions (e.g., protrusions 130) extending from a surface of the washer toward the first end of the sleeve. In some non-limiting embodiments, the threaded post may be engaged with the internal threading of the first end of the sleeve.

In some non-limiting embodiments, the head may include a hook (e.g., hook 206) or a loop. In some non-limiting embodiments, the body may be made of aluminum, stainless steel, or a metal alloy and the resilient polymer of the sleeve may be an elastomer and may include natural rubber, synthetic rubber, silicone, ethylene propylene diene terpolymer (EPDM), a thermoplastic elastomer (TPE), or the like.

The method may further include forming a hole in the wall, such as by predrilling, the diameter of the hole being approximately the same or larger than an outer diameter of the sleeve. Further, the method may include inserting the fastener into the hole such that the protrusions of the washer engage with a surface of the wall. The method may include threading the threaded post further into the internal threading of the sleeve such that a first end of the threaded post extends from the first end of the sleeve, the first end of the sleeve is drawn toward the second end of the sleeve, and the sleeve expands radially and deforms helically such that the sleeve imparts a radial holding force on the hole, a clamping force on the wall, or a combination thereof.

In some non-limiting embodiments, the method may further include removing the fastener from the hole in the wall such as by unthreading the threaded post from the internal threading of the sleeve so that the sleeve is no longer radially expanded or helically deformed and has returned to its original uninstalled form, and thus, there is no clamping force on the wall. In some non-limiting embodiments, the method may then include pulling washer away from the surface of the wall, disengaging and removing the protrusions of the washer from wall, and removing the fastener from the hole in the wall. Once the fastener is pulled out from the hole in wall, the fastener may be used again, and thus, the method may be executed again. For example, in some non-limiting embodiments, the method may further include re-inserting the fastener into the same hole in the wall, or the method may include predrilling a new hole in the wall, the diameter of the new hole being approximately the same or larger than an outer diameter of the sleeve. The method may then be continued as described above.

While several examples of the fastener are shown in the accompanying figures and described in detail hereinabove, other aspects will be apparent to, and readily made by, those skilled in the art without departing from the scope and spirit of the disclosure. Accordingly, the foregoing description is intended to be illustrative rather than restrictive. The disclosure as described hereinabove is defined by the appended claims and all changes that fall within the meaning and range of equivalency of the claims are to be embraced within their scope.

What is claimed is:

1. A reusable hanging fastener with a sleeve for fixing or hanging objects on a wall, the fastener comprising:
a body having a threaded post and a head; and
a sleeve comprised of a resilient polymer, the sleeve further comprising a hollow core, a first end having internal threading, and a second end comprising a washer;
wherein the threaded post is engaged with the internal threading of the first end of the sleeve.

2. The fastener of claim 1, wherein the head further comprises a gripping feature configured to receive a tool.

3. The fastener of claim 2, wherein the gripping feature comprises a screw drive such as Phillips, flat, Allen, hex, or the like.

4. The fastener of claim 1, wherein the body further comprises a spacer between the threaded post and the head.

5. The fastener of claim 4, wherein the spacer comprises a rim protruding from the body and an unthreaded portion between the rim and the head.

6. The fastener of claim 1, wherein the head comprises a hook.

7. The fastener of claim 1, wherein the head comprises a loop.

8. The fastener of claim 1, wherein the threaded post comprises a tapered end having a point.

9. The fastener of claim 1, wherein the body is comprised of aluminum, stainless steel, or a metal alloy.

10. The fastener of claim 1, wherein the washer extends radially from the second end of the sleeve.

11. The fastener of claim 10, wherein the washer comprises protrusions extending from a surface of the washer toward the first end of the sleeve.

12. The fastener of claim 11, wherein the protrusions are pointed teeth.

13. The fastener of claim 1 wherein the resilient polymer is an elastomer comprised of natural rubber, synthetic rubber, silicone, ethylene propylene diene terpolymer (EPDM), a thermoplastic elastomer (TPE), or the like.

14. A reusable hanging fastener with a sleeve for fixing or hanging objects on a wall, the fastener comprising:
a body comprising:
a threaded post;
a head having a gripping feature configured to receive a tool; and
a spacer between the threaded post and the head, the spacer having a rim protruding from the body and an unthreaded portion between the rim and the head; and
a sleeve comprised of a resilient polymer, the sleeve further comprising:
a hollow core;
a first end having internal threading; and
a second end comprising a washer having protrusions extending from a surface of the washer toward the first end of the sleeve,
wherein the threaded post is engaged with the internal threading of the first end of the sleeve, and
wherein the fastener is configured such that as the threaded post is threaded further into the internal threading of the sleeve while the sleeve is engaged with a wall, the first end of the threaded post extends from the first end of the sleeve, the first end of the sleeve is drawn toward the second end of the sleeve, and the sleeve expands radially and deforms helically.

15. The fastener of claim 14, wherein the gripping feature comprises a screw drive such as Phillips, flat, Allen, hex, or the like.

16. The fastener of claim 14, wherein the head comprises a hook or a loop.

17. The fastener of claim 14, wherein the body is comprised of aluminum, stainless steel, or a metal alloy and the resilient polymer is an elastomer comprised of natural rubber, synthetic rubber, silicone, ethylene propylene diene terpolymer (EPDM), a thermoplastic elastomer (TPE), or the like.

18. A method of mounting a fastener to a wall surface, the method comprising:
providing a fastener, the fastener comprising:
a body comprising:
a threaded post;
a head having a gripping feature configured to receive a tool; and
a spacer between the threaded post and the head, the spacer having a rim protruding from the body and an unthreaded portion between the rim and the head; and
a sleeve comprised of a resilient polymer, the sleeve further comprising:
a hollow core;
a first end having internal threading; and
a second end comprising a washer having protrusions extending from a surface of the washer toward the first end of the sleeve,
wherein the threaded post is engaged with the internal threading of the first end of the sleeve, and
wherein the fastener is configured such that as the threaded post is threaded further into the internal threading of the sleeve while the sleeve is engaged with a wall, the first end of the threaded post extends from the first end of the sleeve, the first end of the sleeve is drawn toward the second end of the sleeve, and the sleeve expands radially and deforms helically,
predrilling a hole in the wall, the diameter of the hole being approximately the same or larger than an outer diameter of the sleeve,
inserting the fastener into the hole such that the protrusions engage with a surface of the wall,
threading the threaded post further into the internal threading of the sleeve such that the first end of the threaded post extends from the first end of the sleeve, the first end of the sleeve is drawn toward the second end of the sleeve, and the sleeve expands radially and deforms helically such that the sleeve imparts a radial holding force on the hole, a clamping force on the wall, or a combination thereof.

19. The method of claim 18, wherein the head comprises a hook or a loop.

20. The method of claim 18, wherein the body is comprised of aluminum, stainless steel, or a metal alloy and the resilient polymer is an elastomer comprised of natural rubber, synthetic rubber, silicone, ethylene propylene diene terpolymer (EPDM), a thermoplastic elastomer (TPE), or the like.
